(19) United States
(12) Patent Application Publication
(10) Pub. No.: US 2018/0143615 A1
(43) Pub. Date: May 24, 2018

(54) MANUAL PULSE GENERATING DEVICE

(71) Applicant: FANUC CORPORATION, Yamanashi (JP)

(72) Inventors: Yasuharu Aizawa, Minamitsuru-gun (JP); Hiroshi Okita, Minamitsuru-gun (JP); Hideki Okamura, Minamitsuru-gun (JP); Yuuma Ootsuka, Minamitsuru-gun (JP)

(73) Assignee: FANUC CORPORATION, Yamanashi (JP)

(21) Appl. No.: 15/819,301

(22) Filed: Nov. 21, 2017

(30) Foreign Application Priority Data
Nov. 24, 2016 (JP) 2016-228287

(51) Int. Cl. G05B 19/409

(52) U.S. Cl. CPC G05B 19/409; G05B 2219/43186; G05B 2219/34016; G05B 2219/36463

(57) ABSTRACT

A manual pulse generating device is equipped with a rotatable dial, a pulse generating unit configured to generate drive pulses for commanding axial movement in accordance with an amount of rotation of the dial, an enable switch configured to switch between enablement and disablement of axial movement in accordance with the drive pulses, and a casing having the dial and the enable switch disposed on a surface thereof, and configured to accommodate the pulse generating unit in the interior thereof. The guard configured to cover at least a portion of an outer circumferential surface of the dial is attached to the casing.

### CROSS-REFERENCE TO RELATED APPLICATION

This application is based upon and claims the benefit of priority from Japanese Patent Application No. 2016-228287 filed on Nov. 24, 2016, the contents of which are incorporated herein by reference.

### BACKGROUND OF THE INVENTION

### Field of the Invention

The present invention relates to a manual pulse generating device for enabling manual operation of axial movement.

### Description of the Related Art

In Japanese Laid-Open Patent Publication No. 11-305815, a handy pendant is disclosed which enables a movable body of a machine tool to be moved by way of manual operation. To provide a brief description thereof, the handy pendant includes a dial for generating drive pulses which are proportional to an amount of rotation, and an enable and deadman switch having a primary stop position, and a secondary stop position. The enable and deadman switch forms a manual operating state for the handy pendant when pushed to the primary stop position, and stops the movable body when pushed to the secondary stop position.

In this manner, conventionally, in such a handy pendant (hereinafter referred to as a manual pulse generating device), in order to prevent the dial from being operated contrary to the intentions of the operator, the enable switch is disposed in order to enable the generation of the drive pulses.

### SUMMARY OF THE INVENTION

However, with such a conventional manual pulse generating device, while operating the manual pulse generating device with one hand, it is possible to perform operations of the enable switch and the dial. Consequently, the movable body undergoes movement in the event that the dial is mistakenly operated in a state in which the operator has also operated the enable switch.

Thus, an object of the present invention is to provide a manual pulse generating device which induces or encourages manual operation of axial movements using both hands.

An aspect of the present invention is characterized by a manual pulse generating device, including a rotatable dial, a pulse generating unit configured to generate drive pulses for commanding axial movement in accordance with an amount of rotation of the dial, an enable switch configured to switch between enablement and disablement of axial movement in accordance with the drive pulses, and a casing having the dial and the enable switch disposed on a surface thereof, and configured to accommodate the pulse generating unit in an interior of the casing, wherein a guard configured to cover at least a portion of an outer circumferential surface of the dial is attached to the casing.

According to the present invention, it becomes difficult for the operator to grasp the manual pulse generating device and at the same time carry out manual operation of axial movements with one hand. Accordingly, while the manual pulse generating device is gripped with one hand, it is possible to prevent simultaneous operations of both the dial and the enable switch. Further, since it is difficult to carry out manual operation of axial movements with one hand that has grasped the manual pulse generating device, it is possible to induce or encourage the performance of manual operation of axial movements as well as grasping of the manual pulse generating device using both hands.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is an external perspective view of a manual pulse generating device according to an embodiment of the present invention;

FIG. 2 is an external side view of the manual pulse generating device shown in FIG. 1;

FIG. 3 is a view showing a state in which a guard is attached to a casing of the manual pulse generating device shown in FIG. 1.

FIG. 4 is a view showing a state in which the guard shown in FIG. 3 is attached to the casing of the manual pulse generating device shown in FIG. 2;

FIG. 5 is an external perspective view of a manual pulse generating device according to Modification 2;

FIG. 6 is an external perspective view of a manual pulse generating device according to Modification 3;

FIG. 7 is an external perspective view of a manual pulse generating device according to Modification 4;

FIG. 8 is an external side view of a manual pulse generating device according to Modification 5;

FIG. 9 is a view showing a guard according to Modification 6; and

FIG. 10 is a view showing a guard according to Modification 7.

### DESCRIPTION OF THE PREFERRED EMBODIMENTS

Preferred embodiments of a manual pulse generating device according to the present invention will be presented and described in detail below with reference to the accompanying drawings.

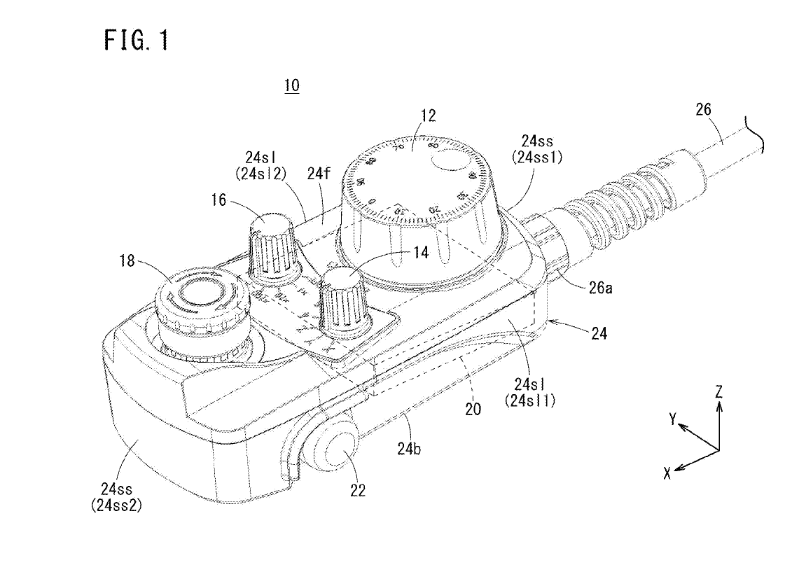

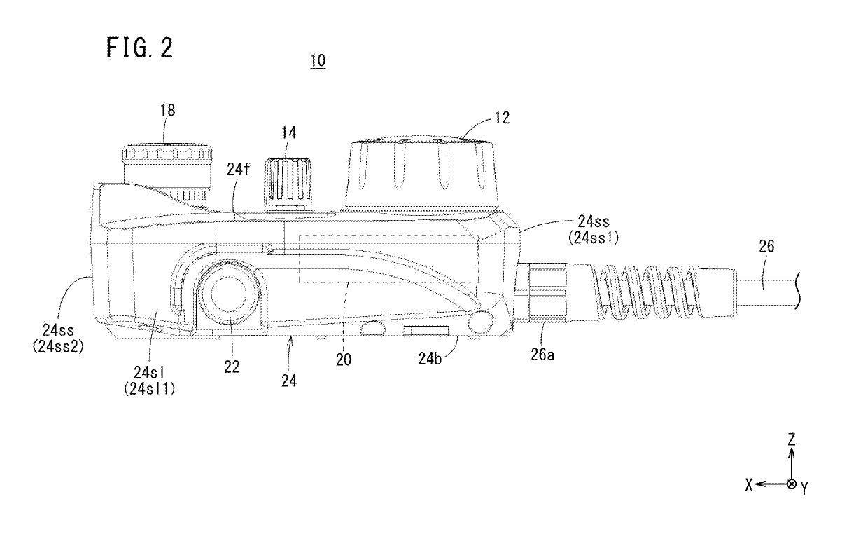

FIG. 1 is an external perspective view of a manual pulse generating device 10, and FIG. 2 is an external side view of the manual pulse generating device 10. The X direction, the Y direction, and the Z direction will be described in accordance with the directions of the arrows shown in FIGS. 1 and 2. Moreover, the X direction, the Y direction, and the Z direction are mutually orthogonal directions, in which the X direction is a lengthwise direction (longitudinal direction), the Y direction is a widthwise direction (lateral direction), and the Z direction is a thickness direction of the manual pulse generating device 10.

The manual pulse generating device 10 is a device for manually operating axial movements of a machine tool. The manual pulse generating device 10 is equipped with a dial 12, an axis selection unit 14, a magnification selection unit 16, an emergency stop switch 18, a pulse generating unit 20, and an enable switch 22. The pulse generating unit 20 is accommodated inside a casing 24 of the manual pulse generating device 10. The dial 12, the axis selection unit 14, the magnification selection unit 16, the emergency stop switch 18, and the enable switch 22 are disposed on a surface of the casing 24. The casing 24 is formed with a maximal length in the longitudinal direction, a second longest length in the widthwise direction, and a shortest length in the thickness direction.

The dial 12, the axis selection unit 14, the magnification selection unit 16, and the emergency stop switch 18 are disposed on a front surface 24f of the casing 24, whereas the enable switch 22 is disposed on a side surface of the casing 24 (a surface in the thickness direction of the casing 24). The dial 12 is disposed on the front surface 24f on one end side (a side in the negative X direction) in the longitudinal direction (X direction) of the casing 24, and the emergency stop switch 18 is disposed on the front surface 24f on another end side (a side in the positive X direction) in the longitudinal direction of the casing 24.

The enable switch 22 is disposed on a side surface 24s11 of the casing 24 on the one end side (a side in the negative Y direction) in the lateral direction of the casing 24, from among the two side surfaces 24s1 that extend along the longitudinal direction of the casing 24, and on the other end side (a side in the positive X direction) in the longitudinal direction of the casing 24. In the present embodiment, when viewed from the center in the longitudinal direction of the casing 24, the side in the negative X direction is defined as the one end side in the longitudinal direction, and the side in the positive X direction is defined as the other end side in the longitudinal direction. Further, when viewed from the center in the lateral direction of the casing 24, the side in the negative Y direction is defined as the one end side in the lateral direction, and the side in the positive Y direction is defined as the other end side in the lateral direction.

The axis selection unit 14 and the magnification selection unit 16 are disposed on the front surface 24f in a central vicinity in the longitudinal direction of the casing 24. The axis selection unit 14 is disposed on the one end side (a side in the negative Y direction) in the lateral direction (width direction, Y direction) of the casing 24, and the magnification selection unit 16 is disposed on the other end side (a side in the positive Y direction) in the lateral direction of the casing 24.

A cable 26 is connected to a side surface 24ss1 of the casing 24 on one end side thereof (a side in the negative X direction) in the longitudinal direction of the casing 24, from among the two side surfaces 24ss of the casing 24 that extend along the lateral direction of the casing 24, so that the cable 26 is drawn out along the longitudinal direction of the casing 24. The cable 26 serves to output an output signal (drive pulses, etc.) from the manual pulse generating device 10 to a numerical controller (not shown) of the machine tool. The cable 26 is disposed at the center in a lateral direction of the side surface 24ss1.

The dial 12 is an operation unit for the purpose of generating drive pulses to manually operate axial movement of the machine tool. The dial has a cylindrical or columnar shape. The dial 12 is rotatable about an axis in the Z direction. In the case that the operator wants the direction of axial movement to be in a positive direction, the operator rotates the dial 12 in the positive direction (clockwise), whereas in the case that the operator wants the direction of axial movement to be in a negative direction, the operator rotates the dial 12 in the negative direction (counterclockwise).

The axis selection unit 14 is operated to select an axis (X-axis, Y-axis, Z-axis, 4th-axis, 5th-axis) of the machine tool to undergo axial movement. The magnification selection unit 16 is operated to select a magnification. The axis selection unit 14 and the magnification selection unit 16 have a cylindrical or columnar shape and are rotatable about axes in the Z direction. The emergency stop switch 18 is a switch for urgently stopping axial movement, and is pressed down by the operator in an emergency situation.

The pulse generating unit 20 generates drive pulses to command axial movement corresponding to an amount of rotation of the dial 12. The pulse generating unit 20 generates positive drive pulses if the dial 12 is rotated in a positive direction, and generates negative drive pulses if the dial 12 is rotated in a negative direction. As the amount at which the dial 12 is rotated by the operator is greater, the number of drive pulses that are generated becomes greater, and the distance of axial movement becomes longer. Further, as the speed of rotation of the dial 12 is made faster, the interval between the generated drive pulses becomes shorter, and therefore, the speed of the axial movement becomes faster. The generated drive pulses are transmitted to the numerical controller of the machine tool via the cable 26. The pulse generating unit 20 also transmits to the numerical controller a signal (hereinafter referred to as an axis signal) to indicate the axis that was selected by the axis selection unit 14, and a signal (hereinafter referred to as a magnification signal) to indicate the magnification that was selected by the magnification selection unit 16.

The numerical controller controls axial movement of the machine tool using the transmitted drive pulses, axis signal, and magnification signal. The numerical controller controls axial movement of the axis that was selected by the axis selection unit 14. When the magnification is times one (×1), the numerical controller moves the selected axis a predetermined distance L by a drive pulse of one pulse. Accordingly, in the case that the selected magnification is times N (×N), the numerical controller moves the selected axis by a distance of L×N by a drive pulse of one pulse. Consequently, the higher the magnification, the movement speed of the axial movement becomes faster, and the distance becomes longer. The pulse generating unit 20 may also generate drive pulses in accordance with the selected magnification and the amount of rotation of the dial 12. In this case, the generated drive pulses are drive pulses which are compensated on the basis of the selected magnification.

The enable switch 22 is a switch for switching between enablement and disablement of axial movement in accordance with the drive pulses. In the case that the enable switch 22 is pressed down by the operator, axial movement in accordance with the drive pulses is enabled and becomes effective, whereas in the case that the enable switch 22 is not pressed, axial movement in accordance with the drive pulses is disabled and becomes ineffective. When the enable switch 22 is pressed down, the pulse generating unit 20 transmits a signal (hereinafter referred to as an enable signal) indicating that the switch is being pressed down, to the numerical controller. During the period in which the enable switch 22 is pressed down, the pulse generating unit 20 continuously transmits the enable signal (high signal) to the numerical controller.

The numerical controller permits axial movement in accordance with the drive pulses only during a period in which the enable signal is transmitted. The pulse generating unit 20 may generate drive pulses only during a period in which the enable switch 22 is pressed down, or may output the generated drive pulses to the numerical controller only during a period in which the enable switch 22 is pressed down.

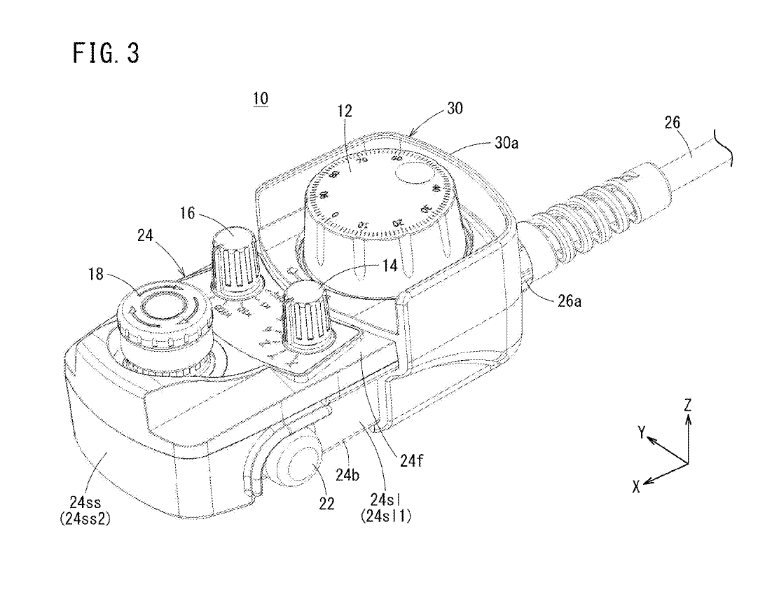

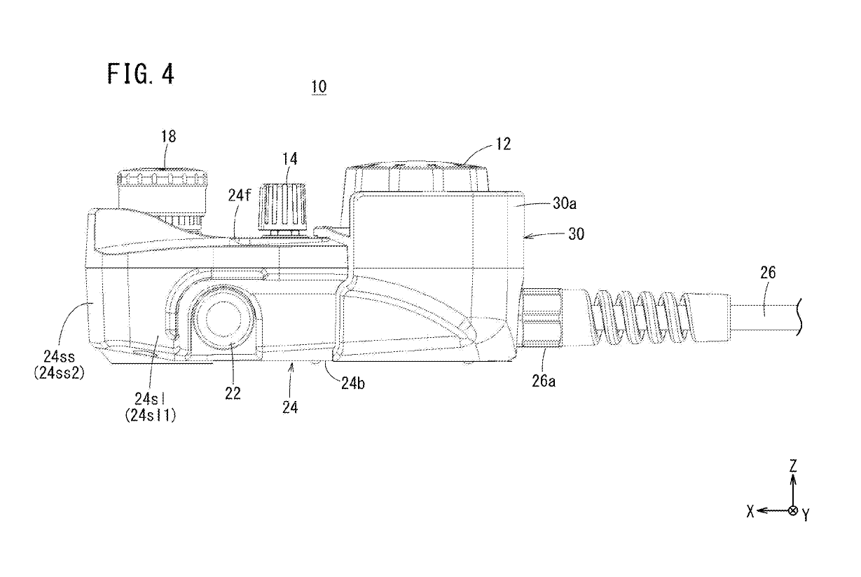

As shown in FIGS. 3 and 4, a guard 30 is attached to the casing 24 of the manual pulse generating device 10. The guard 30 protects at least a portion of the outer circumferential surface of the dial 12. The guard 30 includes a protecting part 30a having a U-shape, and at least a portion of the outer circumferential surface of the dial 12 is protected by the protecting part 30a. While the manual pulse generating device 10 is grasped with one hand, the guard 30 protects at least a portion of the outer circumferential surface of the dial 12, so that simultaneous operations of both the dial 12 and the enable switch 22 cannot be carried out with the one hand.

For example, in the case that the manual pulse generating device 10 (casing 24) is grasped with the left hand, and the enable switch 22 is operated with the thumb of the left hand, the guard 30 is attached to the casing 24 so as to make it impossible to operate the dial 12 with the middle finger, the ring finger, or the little finger of the left hand. Further, in the event that the manual pulse generating device 10 (casing 24) is grasped with the right hand, and the enable switch 22 is operated with the index finger or the middle finger of the right hand, the guard 30 is attached to the casing 24 so as to make it impossible to operate the dial 12 with the thumb of the right hand.

The protecting part 30a of the guard 30 is formed up to a height at which the outer circumferential surface of an upper portion of the dial 12 remains exposed. Moreover, the protecting part 30a of the guard 30 may be formed to extend up to a height that covers the entire outer circumferential surface of the dial 12. In either of these cases, the operator operates the enable switch 22 with the one hand that has grasped the manual pulse generating device 10 (casing 24), while operates the dial 12 with the other hand that is not grasping the manual pulse generating device 10.

In this manner, by attaching the guard 30 to the casing 24, it becomes difficult for the operator to grasp the manual pulse generating device 10 (casing 24) and at the same time carry out manual operation of axial movements with one hand. Accordingly, while the manual pulse generating device 10 (casing 24) is grasped with one hand, it is possible to prevent simultaneous operations of both the dial 12 and the enable switch 22 with the one hand. Further, since it is difficult to carry out manual operation of axial movements with the one hand that has grasped the manual pulse generating device 10 (casing 24), it is possible to induce or encourage the performance of manual operation of axial movements as well as grasping of the manual pulse generating device 10 using both hands.

Moreover, the guard 30 is attached to the casing 24 by a screw member such as a screw or a bolt or the like, which can be tightened using a specialized tool (for example, a star-shaped driver). Accordingly, the guard 30 cannot be removed from the casing 24 with a general tool (a cross-head screwdriver, a straight-head screwdriver) or a coin or the like. Stated otherwise, the guard 30 is attached in such a manner that it cannot be easily removed.

The guard 30 is preferably constituted from an elastic material such as a rubber material. However, the guard 30 may be constituted from a resin material such as plastic or the like. Further, the guard 30 may be constituted from the same material (a resin material such as plastic or the like) as the casing 24. By constituting the guard 30 from an elastic member, even in the case that the operator drops the manual pulse generating device 10 by mistake, at least the dial 12 can be protected by the guard 30. Further, the guard 30 may be formed so as to cover the front surface 24f of the casing 24 from the side, so as to protect at least portions of the axis selection unit 14, the magnification selection unit 16, and the emergency stop switch 18.

### [Modifications]

The above-described embodiment may be modified in the following manner.

(Modification 1) In the above-described embodiment, the enable switch 22 is disposed on a side surface 24s11 of the casing 24 on the one end side (a side in the negative Y direction) in the lateral direction of the casing 24, from among the two side surfaces 24s1 that extend along the longitudinal direction of the casing 24. However, the enable switch 22 may be provided on a side surface 24s12 on the other end side (a side in the positive Y direction) in the lateral direction of the casing 24. Further, in Modification 1 as well, the enable switch 22 is disposed on the other end side (a side in the positive X direction) in the longitudinal direction of the casing 24.

In the case of Modification 1 as well, since the guard 30 is attached to the casing 24, it becomes difficult for the operator to grasp the manual pulse generating device 10 (casing 24) and at the same time carry out manual operation of axial movements with one hand. Accordingly, while the manual pulse generating device 10 (casing 24) is grasped with one hand, it is possible to prevent simultaneous operations of both the dial 12 and the enable switch 22 with the one hand. Further, since it is difficult to carry out manual operation of axial movements with the one hand that has grasped the manual pulse generating device 10 (casing 24), it is possible to induce or encourage the performance of manual operation of axial movements as well as grasping of the manual pulse generating device 10 using both hands.

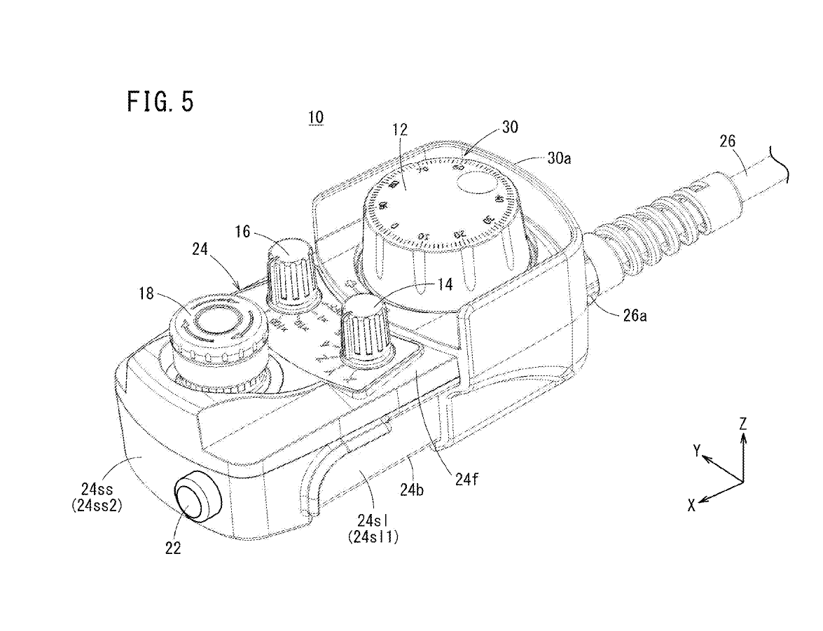

(Modification 2) In the above-described embodiment, the enable switch 22 is disposed on a side surface 24s11 of the casing 24 that extends along the longitudinal direction thereof. However, as shown in FIG. 5, the enable switch 22 may be disposed on a side surface 24ss2 of the casing 24 on the other end side (a side in the positive X direction) in the longitudinal direction of the casing 24, from among the two side surfaces 24ss that extend along the lateral direction of the casing 24. At this time, the enable switch 22 may also be disposed on the one end side (a side in the negative Y direction) in the lateral direction of the casing 24 (see FIG. 5), or may be disposed on the center in the lateral direction of the casing 24, or may be disposed on the other end side (a side in the positive Y direction) in the lateral direction of the casing 24.

In accordance with these features, it becomes more difficult for the operator to grasp the manual pulse generating device 10 (casing 24) and at the same time carry out manual operation of axial movements with one hand. Accordingly, while the manual pulse generating device 10 (casing 24) is grasped with one hand, it is possible to prevent simultaneous operations of both the dial 12 and the enable switch 22 with the one hand. Further, since it is difficult to carry out manual operation of axial movements with the one hand that has grasped the manual pulse generating device 10 (casing 24), it is possible to induce or encourage the performance of manual operation of axial movements as well as grasping of the manual pulse generating device 10 using both hands. Moreover, in the case of Modification 2, the guard 30 need not necessarily be attached to the casing 24.

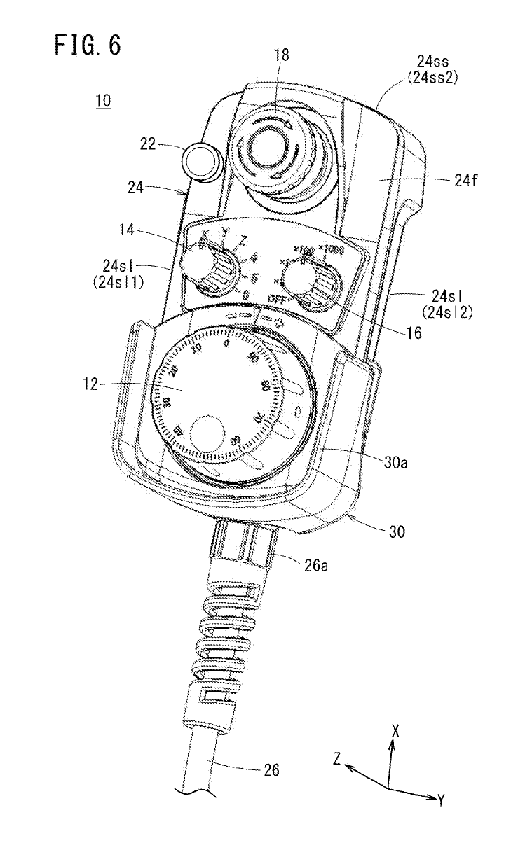

(Modification 3) In the above-described embodiment, the enable switch 22 is disposed on a side surface 24s11 that extends along the longitudinal direction of the casing 24. However, as shown in FIG. 6, the enable switch 22 may be disposed on the front surface 24f of the casing 24 on the other end side (a side in the positive X direction) in the longitudinal direction of the casing 24. At this time, the enable switch 22 may also be disposed on the one end side (a side in the negative Y direction) in the lateral direction of the casing 24 (see FIG. 6), or may be disposed on the other end side (a side in the positive Y direction) in the lateral direction of the casing 24.

In accordance with these features, it becomes more difficult for the operator to grasp the manual pulse generating device 10 (casing 24) and at the same time carry out manual operation of axial movements with one hand. Accordingly, while the manual pulse generating device 10 (casing 24) is grasped with one hand, it is possible to prevent simultaneous operations of both the dial 12 and the enable switch 22 with the one hand. Further, since it is difficult to carry out manual operation of axial movements with the one hand that has grasped the manual pulse generating device 10 (casing 24), it is possible to induce or encourage the performance of manual operation of axial movements as well as grasping of the manual pulse generating device 10 using both hands. Moreover, in the case of Modification 3, the guard 30 need not necessarily be attached to the casing 24.

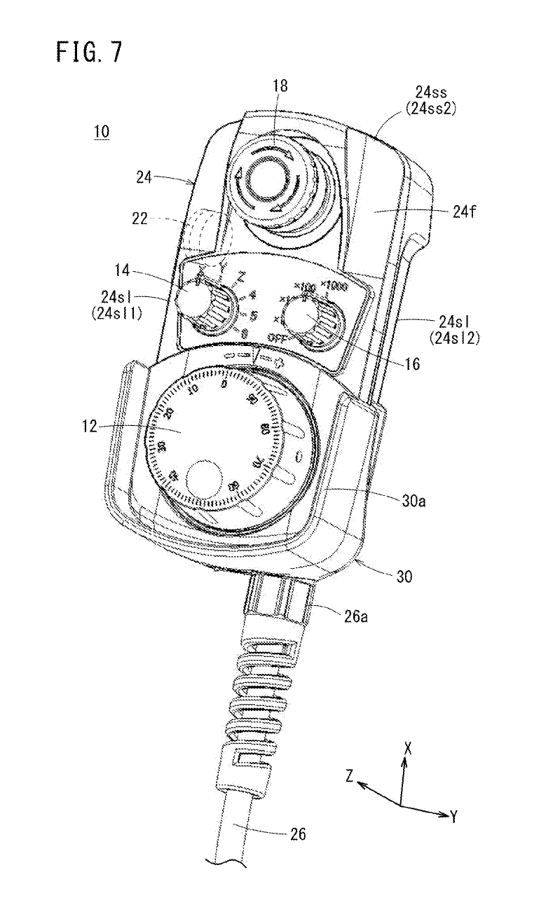

(Modification 4) In order to firmly grasp the manual pulse generating device 10, there is a tendency for the operator to grasp the casing 24 while holding a proximal end portion 26a of the cable 26 (a portion where the cable 26 is connected with the casing 24). Consequently, according to Modification 4, and as shown in FIG. 7, the cable 26 is disposed on the other end side (a side in the positive Y direction) on an opposite side from the one end side (a side in the negative Y direction) in the lateral direction of the casing 24 where the enable switch 22 is disposed. Stated otherwise, the cable 26 is disposed on the one end side (a side in the negative X direction) in the longitudinal direction of the casing 24 as well as on the other end side (a side in the positive Y direction) in the lateral direction of the casing 24.

In accordance with this feature, it becomes difficult for the operator to operate the enable switch 22 with the one hand that has grasped the manual pulse generating device 10 (casing 24) while at the same time holding the proximal end portion 26a of the cable 26. Accordingly, it is possible to induce or encourage manual operation of axial movements using both hands. Moreover, in Modification 4 as well, the cable 26 is connected to a side surface 24ss1 on the one end side (a side in the negative X direction) in the longitudinal direction, from among the two side surfaces 24ss that extend along the lateral direction of the casing 24. Moreover, in the case of Modification 4, the guard 30 need not necessarily be attached to the casing 24.

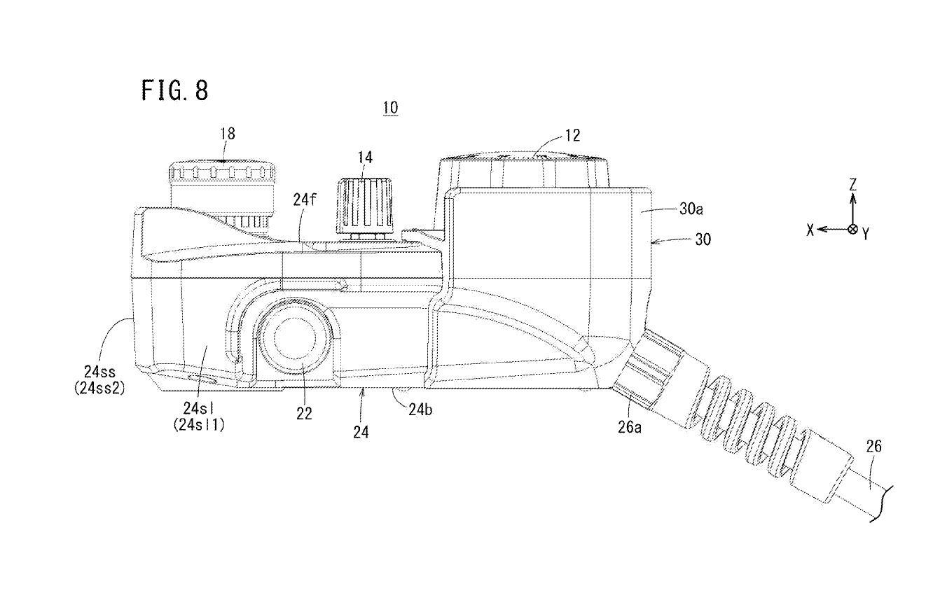

(Modification 5) As shown in FIG. 8, the cable 26 may be disposed so as to be separated from the dial 12, and so as to be drawn out from a rear surface 24b of the casing 24 and obliquely with respect to the longitudinal direction of the casing 24. Stated otherwise, the cable 26 is disposed on the one end side (a side in the negative X direction) in the longitudinal direction of the casing 24, so as to extend in the negative X direction and the negative Z direction from the rear surface 24b side of the casing 24.

In accordance with this feature, while holding the proximal end portion 26a of the cable 26, it becomes difficult for the operator to operate the dial 12 with the one hand that has grasped the manual pulse generating device 10 (casing 24) to which the guard 30 is attached. Accordingly, it is possible to induce or encourage manual operation of axial movements using both hands. Moreover, in Modification 5, the cable 26 is connected in a straddling manner between the rear surface 24b of the casing 24, and the side surface 24ss1 on the one end side (a side in the negative X direction) in the longitudinal direction, from among the two side surfaces 24ss that extend along the lateral direction of the casing 24.

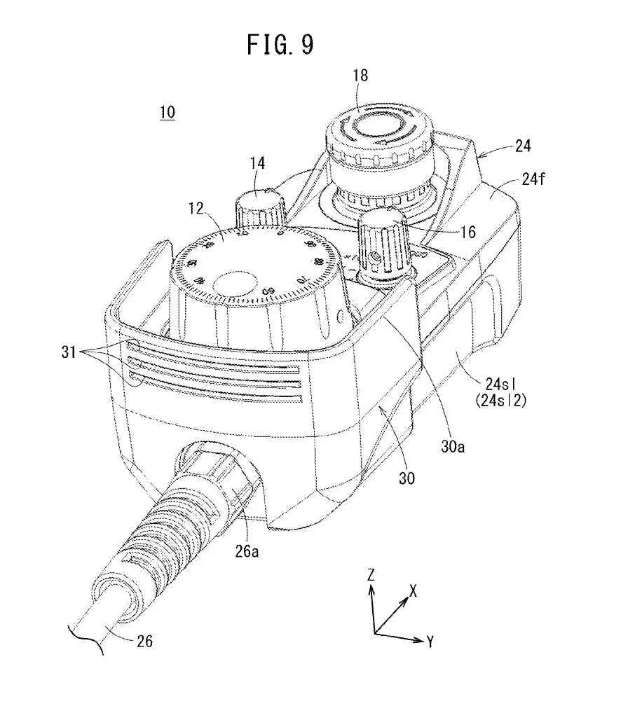

(Modification 6) In certain cases, because of being used in an environment where oil adheres to the manual pulse generating device 10, oil may become accumulated in the guard 30. Therefore, according to Modification 6, as shown in FIG. 9, the guard 30 is formed with discharge ports 31 therein for the purpose of discharging oil that has accumulated in the guard 30. The discharge ports 31 are formed in the protecting part 30a. In accordance with this feature, it is possible to prevent oil from accumulating in the guard 30.

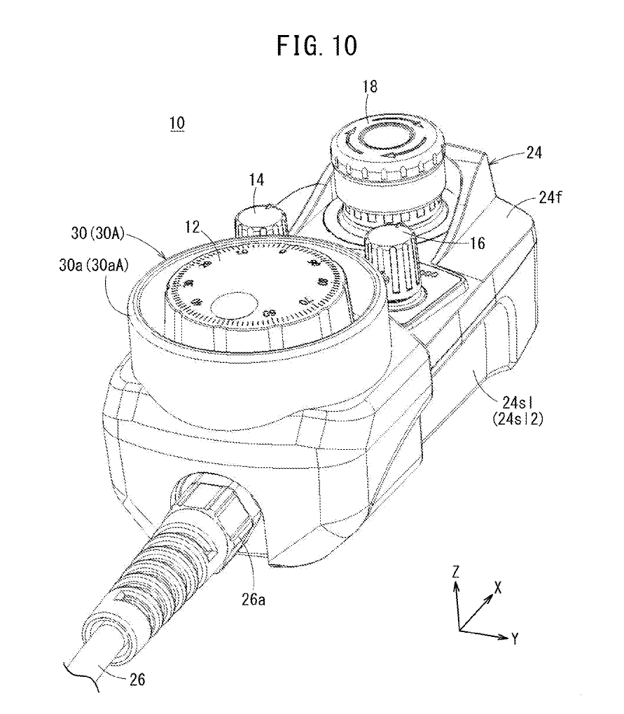

(Modification 7) According to the present embodiment, a description has been given in which the guard 30 has a U-shaped protecting part 30a that covers a portion of the outer peripheral surface of the dial 12. However, a plurality of guards 30 having different shapes may be prepared in advance, and an arbitrary one of such guards 30 may be attached to the casing 24. For example, as shown in FIG. 10, a guard 30 (30A) may be attached to the casing 24 having an annular protecting part 30a (30aA) which covers the entire outer circumferential surface in the circumferential direction of the dial 12. The shape of the guard 30 to be attached may be determined arbitrarily by the operator that uses the manual pulse generating device 10. In accordance with this feature, the operator is capable of attaching an appropriate guard 30 to the casing 24. Further, an appropriate guard 30 may be attached corresponding to the shape of the manual pulse generating device 10 (casing 24).

(Modification 8) The features of the aforementioned Modifications 1 through 7 may be combined without causing inconsistency.

As described above, the manual pulse generating device 10 according to the above-described embodiment as well as Modifications 1 through 8 is equipped with the rotatable dial 12, the pulse generating unit 20 adapted to generate drive pulses for commanding axial movements in accordance with an amount of rotation of the dial 12, the enable switch 22 that switches between enablement and disablement of the axial movements in accordance with the drive pulses, and the casing 24 having the dial 12 and the enable switch 22 disposed on surfaces thereof, together with accommodating the pulse generating unit 20 in the interior of the casing 24. The guard 30, which covers at least a portion of the outer circumferential surface of the dial 12, is attached to the casing 24.

In accordance with these features, it becomes difficult for the operator to grasp the manual pulse generating device 10 (casing 24) and at the same time carry out manual operation of axial movements with one hand. Accordingly, while the manual pulse generating device 10 (casing 24) is grasped with one hand, it is possible to prevent simultaneous operations of both the dial 12 and the enable switch 22. Further, since it is difficult to carry out manual operation of axial movements with the one hand that has grasped the manual pulse generating device 10 (casing 24), it is possible to induce or encourage the performance of manual operation of axial movements as well as grasping of the manual pulse generating device 10 using both hands.

The dial 12 is disposed on the front surface 24f of the casing 24 on one end side (the side in the negative X direction) in the longitudinal direction of the casing 24. The enable switch 22 is disposed on the other end side (the side in the positive X direction) in the longitudinal direction of the casing 24. Consequently, since it is possible to lengthen the distance between the installed position of the dial 12 and the installed position of the enable switch 22, it becomes more difficult for the dial 12 and the enable switch 22 to be simultaneously operated with the one hand that has grasped the manual pulse generating device 10, and it is possible to induce or encourage the performance of manual operation of axial movements using both hands.

The enable switch 22 may be disposed on the front surface 24f of the casing 24. In accordance with this feature, it becomes more difficult for the dial 12 and the enable switch 22 to be simultaneously operated with the one hand that has grasped the manual pulse generating device 10, and it is possible to induce or encourage the performance of manual operation of axial movements using both hands.

Further, the enable switch 22 may be disposed on a side surface of the casing 24. For example, by providing the enable switch 22 on the side surface 24ss2 that extends along the lateral direction of the casing 24, it becomes more difficult for the dial 12 and the enable switch 22 to be simultaneously operated with the one hand that has grasped the manual pulse generating device 10, and it is possible to induce or encourage the performance of manual operation of axial movements using both hands.

The cable 26, which is connected to a machine tool in order to output drive pulses to the machine tool, is disposed on the one end side of the casing 24 (a side in the negative X direction) in the longitudinal direction thereof on which the dial 12 is disposed.

The enable switch 22 may be disposed on one end side of the casing 24 (a side in the negative Y direction) in the lateral direction of the casing 24, and the cable 26 may be disposed on the other end side of the casing 24 (a side in the positive Y direction) in the lateral direction of the casing 24, so as to be drawn out along the longitudinal direction of the casing 24. In accordance with this feature, it becomes difficult for the operator to operate the enable switch 22 with one hand that has grasped the manual pulse generating device 10 (casing 24) while at the same time holding the proximal end portion 26a of the cable 26. Accordingly, it is possible to induce or encourage manual operation of axial movements using both hands.

The cable 26 may be disposed so as to be drawn out from the side of a rear surface 24b of the casing 24 and obliquely with respect to the longitudinal direction of the casing 24, and so as to be separated away from the dial 12. In accordance with this feature, while holding the proximal end portion 26a of the cable 26, it becomes difficult for the operator to operate the dial 12 with the one hand that has grasped the manual pulse generating device 10 (casing 24) to which the guard 30 is attached. Accordingly, it is possible to induce or encourage manual operation of axial movements using both hands.

The guard 30 may be mounted detachably to the casing 24. In accordance with this feature, the operator is capable of attaching an appropriate guard 30 to the casing 24.

The discharge ports 31 for allowing liquid that has accumulated in the guard 30 to be discharged may be formed in the guard 30. In accordance with this feature, it is possible to prevent oil from accumulating in the guard 30.

The guard 30 may be constituted from an elastic material. In accordance with this feature, even in the event that the operator drops the manual pulse generating device 10 by mistake, at least the dial 12 can be protected by the guard 30.

While the invention has been particularly shown and described with reference to preferred embodiments, it will be understood that variations and modifications can be effected thereto by those skilled in the art without departing from the scope of the invention as defined by the appended claims.

What is claimed is:

1. A manual pulse generating device, comprising:
a rotatable dial;
a pulse generating unit configured to generate drive pulses for commanding axial movement in accordance with an amount of rotation of the dial;
an enable switch configured to switch between enablement and disablement of axial movement in accordance with the drive pulses; and
a casing having the dial and the enable switch disposed on a surface thereof, and configured to accommodate the pulse generating unit in an interior of the casing;
wherein a guard configured to cover at least a portion of an outer circumferential surface of the dial is attached to the casing.

2. The manual pulse generating device according to claim 1, wherein:
the dial is disposed on a front surface of the casing on one end side in a longitudinal direction of the casing; and
the enable switch is disposed on another end side in the longitudinal direction of the casing.

3. The manual pulse generating device according to claim 2, wherein the enable switch is disposed on the front surface of the casing.

4. The manual pulse generating device according to claim 2, wherein the enable switch is disposed on a side surface of the casing.

5. The manual pulse generating device according to claim 4, wherein the enable switch is disposed on a side surface of the casing that extends along a lateral direction of the casing.

6. The manual pulse generating device according to claim 2, wherein a cable, which is connected to a machine tool in order to output the drive pulses to the machine tool, is disposed on the one end side in the longitudinal direction of the casing on which the dial is disposed.

7. The manual pulse generating device according to claim 6, wherein:
the enable switch is disposed on one end side in a lateral direction of the casing; and
the cable is disposed on another end side in the lateral direction of the casing, so as to be drawn out along the longitudinal direction of the casing.

8. The manual pulse generating device according to claim 6, wherein the cable is disposed so as to be drawn out from a rear surface side of the casing and obliquely with respect to the longitudinal direction of the casing, and so as to be separated away from the dial.

9. The manual pulse generating device according to claim 1, wherein the guard is mounted detachably to the casing.

10. The manual pulse generating device according to claim 1, wherein a discharge port, which is configured to allow liquid that has accumulated in the guard to be discharged, is formed in the guard.

11. The manual pulse generating device according to claim 1, wherein the guard is constituted from an elastic material.
